(19) United States
(12) Patent Application Publication
(10) Pub. No.: US 2017/0115886 A1
(43) Pub. Date: Apr. 27, 2017

(54) STORAGE DEVICE AND METHOD OF PERFORMING A WRITE OPERATION BY THE SAME

(71) Applicant: Samsung Electronics Co., Ltd., Suwon-si (KR)

(72) Inventors: NEERAJ LADKANI, Bangalore (IN); Vikram Singh, Karnataka (IN); Srinivasa Raju Nadakuditi, Karnataka (IN)

(73) Assignee: Samsung Electronics Co., Ltd., Suwon-si (KR)

(21) Appl. No.: 15/168,381

(22) Filed: May 31, 2016

(30) Foreign Application Priority Data
Oct. 26, 2015 (IN) 5748/CHE/2015

(51) Int. Cl. G06F 3/06; G06F 12/10; G06F 12/08

(52) U.S. Cl. CPC G06F 3/0605; G06F 3/0653; G06F 3/0659; G06F 3/0665; G06F 3/0679; G06F 12/0804; G06F 12/10; G06F 2212/152; G06F 2212/214; G06F 2212/608; G06F 2212/7201

(57) ABSTRACT

A storage device and a method of performing a write operation by the same are provided. The method of performing a write operation by a storage device include detecting a write operation using a PCIe (Peripheral Component Interconnect Express) write TLP (Transaction Layer Packet) and automatically performing said write operation of data to a storage medium in said storage device based on at least one criterion, without receiving an explicit command from a host device.

### CROSS-REFERENCE TO RELATED APPLICATION

This application claims the benefit of priority under 35 U.S.C. §119 to Indian Patent Application No. 5748/CHE/2015 filed on Oct. 26, 2015 in the Indian Intellectual Property Office, the disclosure of which is incorporated by reference in its entirety herein.

### BACKGROUND

1. Field

Some example embodiments relate to the performance of a write operation in a storage device and, more particularly to, a method for automatically performing a write operation by the storage device.

2. Description of the Related Art

Computer systems generally employ data storage devices, such as disk drive devices, or solid-state storage devices, for storage and retrieval of large amounts of data. Arrays of solid-state storage devices, such as flash memory, phase change memory, memristors, and/or other non-volatile storage units, may also be used in data storage systems.

Storage is moving away from legacy usage models. New use cases require direct access to storage as native memory subsystems. Currently, read and write operations to a storage device are achieved using CPU instructions, such as Load and Store, which means a host device must issue a specific command to a storage device in order to commit write operation to the non-volatile memory.

In existing systems, a host device needs to manually issue a Write command to write the data into a storage medium. And in the case where the storage device implements volatile cache, the host needs to manually issue a Flush command in order to flush data from the cache to the storage medium.

The above information is presented as background information only to help the reader understand various example embodiments of the inventive concepts. Applicants have made no determination and make no assertion as to whether any of the above might be applicable as Prior Art with regard to the present application.

### SUMMARY

At least one example embodiment of the present inventive concepts provides a method implemented in a storage device to automatically perform a write operation of data to a non-transitory storage medium without receiving an explicit command from a host device.

At least one example embodiment of the present inventive concepts provides a storage device to automatically perform a write operation of data to a non-transitory storage medium without receiving an explicit command from a host device.

At least one example embodiment of the present inventive concepts provides a storage device to flush data from a cache to a NAND (e.g., NAND memory).

These and other objects of the present inventive concepts will be described in or be apparent from the following description of various example embodiments.

According to some example embodiments of the present inventive concepts, there is provided method of performing a write operation using a storage device, the method comprising detecting a write operation using a PCIe (Peripheral Component Interconnect Express) write TLP (Transaction Layer Packet) and automatically performing the write operation of data to a non-transitory storage medium included with the storage device based on at least one desired criterion, without receiving an explicit command from a host device.

In some example embodiments of the present inventive concepts, the detecting the write operation using the PCIe write TLP may include receiving a LBA (logical block address) mapping command from the host device, the LBA mapping command indicating mapping of an LBA to a cache buffer index.

In some example embodiments of the present inventive concepts, the at least one of the desired criterions may include a battery backup presence criterion, a cache size criterion, and a device policy criterion.

In some example embodiments of the present inventive concepts, the automatically performing the write operation of the data to the non-transitory storage medium may include flushing the data from a cache to the non-transitory storage medium.

According to some example embodiments of the present inventive concepts, there is provided a storage device comprising at least one processor configured to detect a write operation using a PCIe (Peripheral Component Interconnect Express) write TLP (Transaction Layer Packet) and automatically perform said write operation of data to a non-transitory storage medium included in the storage device based on at least one desired criterion, without receiving an explicit command from a host device.

In some example embodiments of the present inventive concepts, the detect the write operation using the PCIe write TLP may include receiving a LBA (logical block address) mapping command from the host device, the LBA mapping command indicating a mapping of an LBA to a cache buffer index.

In some example embodiments of the present inventive concepts, the at least one said criterion may comprise a battery backup presence criterion, a cache size criterion, and a device policy criterion.

In some example embodiments of the present inventive concepts, the automatically perform the write operation of the data to the storage medium may include flushing the data from a cache to the storage medium.

According to some example embodiments of the present inventive concepts, there is provided a method comprising receiving, using at least one processor, a Peripheral Component Interconnect Express (PCIe) Transaction Layer Packet (TLP) related to a data storage device, the received TLP including data, determining, using the at least one processor, whether the received TLP relates to a write command and whether at least one desired criterion is satisfied, and based on results of the determining, automatically performing, using the at least one processor, a write operation using the data to the data storage device.

In some example embodiments, the data storage device may include a NAND type non-transitory computer readable medium.

In some example embodiments, the at least one desired criterion may be a battery backup presence criterion, a cache size criterion, and a device policy criterion.

In some example embodiments, the method may further include determining, using the at least one processor, whether a power failure event has occurred, and based on results of the determining whether a power failure event has occurred, automatically performing, using the at least one processor, a write operation using data stored in a cache related to the data storage device to the NAND type non-transitory computer readable medium.

### BRIEF DESCRIPTION OF THE DRAWINGS

The foregoing and other features of inventive concepts will be apparent from the more particular description of non-limiting example embodiments of inventive concepts, as illustrated in the accompanying drawings in which like reference characters refer to like parts throughout the different views. The drawings are not necessarily to scale, emphasis instead being placed upon illustrating principles of inventive concepts. In the drawings:

FIG. 1 is a schematic block diagram illustrating a system including a storage device for automatically performing write operation, according to at least one example embodiment as disclosed herein;

FIG. 2 is a flow diagram illustrating a method of automatically performing write operation of data to a non-transitory storage medium, according to at least one example embodiment as disclosed herein;

FIG. 3 shows implementation of the proposed system, according to at least one example embodiment as disclosed herein;

FIG. 4 shows an example page mapping, according to at least one example embodiment as disclosed herein; and

FIG. 5 is a schematic block diagram illustrating a system of triggering automatic flush operation from volatile cache by a storage device, according to at least one example embodiment as disclosed herein.

### DETAILED DESCRIPTION

Various example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Throughout the description, the terms host and host device are used interchangeably.

The example embodiments described and/or illustrated herein achieve a method of performing a write operation by a storage device. The method includes detecting a write operation using a PCIe (Peripheral Component Interconnect Express) write TLP (Transaction Layer Packet). Further, the method includes automatically performing the write operation of data to a non-transitory storage medium based on one or more criteria, without receiving an explicit command from a host device.

In at least one example embodiment, the non-transitory storage medium is a NAND.

In at least one example embodiment, the write operation is detected using the write TLP includes receiving a LBA (logical block address) mapping command from the host device which indicates mapping of a LBA to a cache buffer index.

In at least one example embodiment, the criteria can be a battery backup, a cache size, and a device policy.

In at least one example embodiment, automatically performing write operation of the data to the NAND includes flushing the data from a device cache to the NAND.

If the storage device cache is not power backed (e.g., is not powered by a backup power source, such as a battery, etc.), on each PCIe Write TLP, the storage device is configured to automatically commit the data to the NAND. The device will decide how much data needs to be written. In this case, there is no data loss from host in case of a sudden power OFF (SPOR). In the proposed method, the host is not required to book-keep the LBAs which are not flushed to NAND (e.g., the host is not required to maintain state information regarding the LBAs and whether they have been flushed to the NAND or not). This reduces the need for periodic flush commands issuing from the host.

If the storage device cache is power backed, on each PCIe write TLP, a “Flush Decision Trigger Logic” engine will keep the track of total data in the cache. The storage device knows how much “Power Backup” (e.g., the backup power level information) is provided in the storage device and based on the Power Backup information decides how much data can be kept in the cache at any given point in time. If the data has crossed the threshold, “Flush Decision Trigger Logic” triggers the flush operation. The device decides which data needs to be flushed to the NAND. In the proposed method, the host is not required to book-keep LBAs which are not flushed to NAND. This reduces the amount of periodic flush from the host. This method requires less overhead in terms of Program Cycles (e.g., program-erase cycles of the NAND storage device) to write the data to the NAND. Hence, there is no early wear-out issues regarding the NAND storage device, which has a finite number of Program Cycles before the performance integrity of the NAND storage device degrades and/or stops functioning.

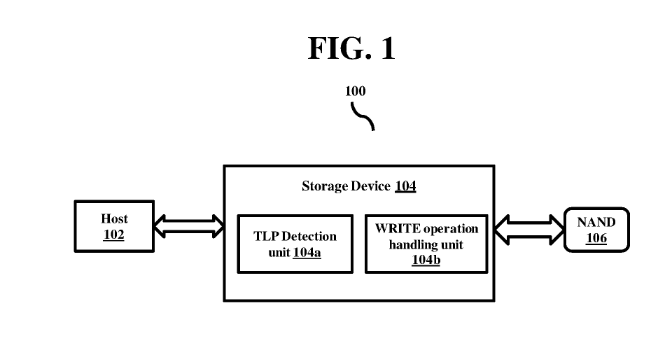

Referring now to the drawings, and more particularly to FIGS. 1 through 5, where similar reference characters denote corresponding features consistently throughout the figures, there are shown various example embodiments.

FIG. 1 is a schematic block diagram illustrating a system 100 including a storage device for automatically performing write operation, according to at least one example embodiment disclosed herein. The system 100 includes a host 102 and a storage device 104. The host 102 may be a computer such as a server, laptop, desktop, networked computer, etc., or any other computing device, such as a smartphone, tablet, gaming console, personal digital assistant (PDA), television, Internet of Things (IoT) device, wearable device, other smart device, etc. The host 102 typically includes components (not shown) such as memory, one or more processors, buses, and other components. The host 102 stores data in the storage device 104 and communicates data with the storage device 104 through a communication connection (not shown). The storage device 104 may be internal to the host 102 or external to the host 102. The communication connection may be a bus, a network, or other manner of connection allowing the transfer of data between the host 102 and the storage device 104. In at least one example embodiment, the storage device 104 is connected to the host 102 by a PCI connection, such as PCI express (“PCIe”). The storage device 104 may be a card that plugs into a PCIe connection on the host 102. The storage device 104 provides non-volatile storage for the host 102. In at least one example embodiment, the non-volatile storage is a NAND memory 106.

The NAND memory 106 stores data such that the data is retained even when the storage device 104 is not powered.

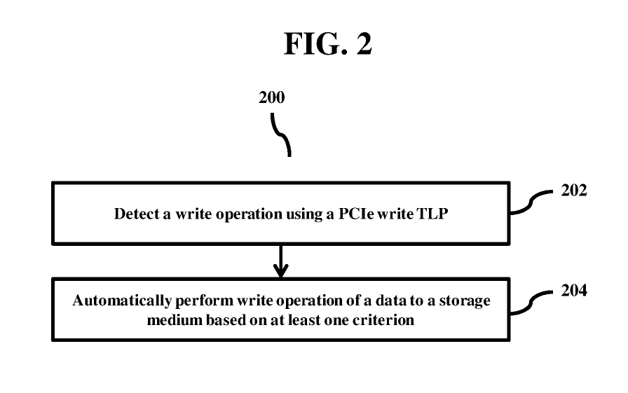

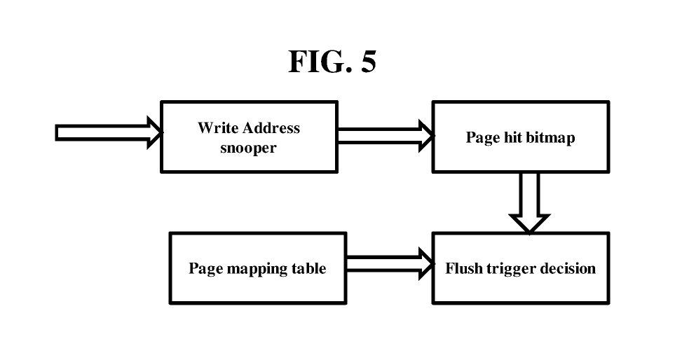

As shown, the storage device 104 includes a TLP Detection unit 104a and a write operation handling unit 104b. The operations performed by these units are explained in conjunction with FIG. 2 and FIG. 5.

FIG. 2 is a flow diagram illustrating a method 200 of automatically performing write operation of data to a non-transitory storage medium, according to various example embodiments as disclosed herein. The sequence of steps can be performed inside the storage device 104 by using the microcontroller, the microprocessor, the controller unit and/or any non-transitory computer readable storage medium. In at least one example embodiment, the non-transitory storage medium is NAND memory 106. At step 202, the method 200 includes detecting a write operation using a PCIe write TLP. In at least one example embodiment, the method 200 allows the TLP Detection unit 104a to detect the write operation performed by the storage device 104 using the PCIe write TLP. In the method 200, the host has not sent an explicit command to write data in the NAND 106. In at least one example embodiment, the host may issue a LBA mapping command to the storage device 104 upon the first time the host attempts to access an LBA (e.g., either a read or write to LBA). The LBA mapping command maps the LBA to the cache buffer index. At step 204, the method 200 includes automatically performing the write operation of data to a NAND or other type of memory in a storage device 104 based on at least one criterion. In at least one example embodiment, the method 200 allows the WRITE operation handling unit 104b to automatically perform the write operation of the data to the NAND 106 or other type of memory in the storage device 104 based on one or more criteria.

In at least one example embodiment, the criteria may be based on the presence of a battery backup for the non-transitory storage medium, based on a cache size, based on a device policy, etc.

In at least one example embodiment, the WRITE operation handling unit 104b determines and/or identifies that the storage device 104 is battery backed, or in other words, the storage device 104 has a battery backup. Based on this, the WRITE operation handling unit 104b automatically performs the write operation to the NAND memory 106.

In at least one example embodiment, the WRITE operation handling unit 104b considers a cache size to perform the write operation. Based on the cache size, the WRITE operation handling unit 104b automatically performs the write operation to the NAND memory 106. If the cache size has reached a desired threshold and/or maximum limit, then the data in the cache can be flushed to the NAND memory 106.

In at least one example embodiment, the WRITE operation handling unit 104b considers the device policy to write data to the NAND memory 106. For example, the device policy may be a desired and/or predefined policy stored in the storage device 104.

In another example embodiment, the host sends the device policy to the storage device 104.

In at least one example embodiment, the WRITE operation handling unit 104b considers a combination of criteria to automatically perform the write operation of the data to the NAND memory 106.

In another example embodiment, the WRITE operation handling unit 104b considers only one criterion to automatically perform the write operation of the data to the NAND memory 106.

The storage device 104 may support an assured/guaranteed threshold cache size which will be committed during a sudden power OFF (SPOR) event. In other words, the storage device 104, upon the detection or occurrence of a SPOR event, may automatically perform the write operation of data stored in a cache up to and including a desired cache size.

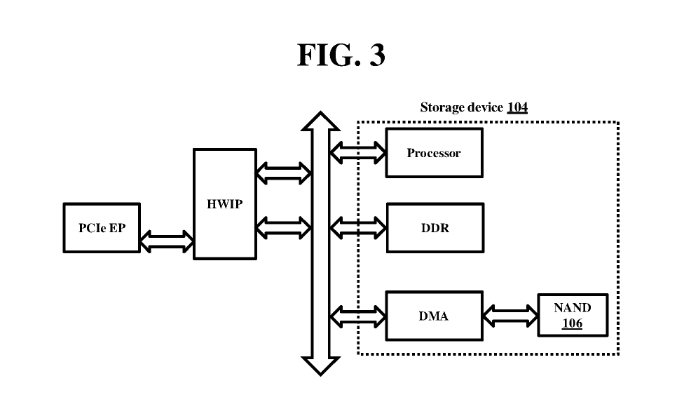

FIG. 3 shows implementation of the proposed system, according to at least one example embodiment as disclosed herein. The PCIe end point (EP) receives a write TLP from a host and passes the write TLP to internal processing units. Through the interfaces, the storage device 104 detects a write operation using the write TLP. The operation of a processor, a double-data-rate (DDR) random access memory (RAM), and a direct memory access (DMA) remains unaltered according to this example embodiment.

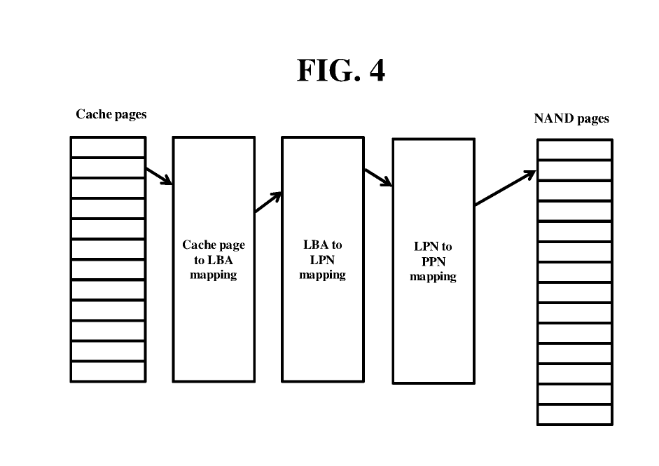

FIG. 4 shows an example page mapping, according to at least one example embodiment as disclosed herein. As shown in the FIG. 4, the cache pages are mapped to an LBA and the LBA is mapped to a Logical Page Number (LPN) table. Further, the LPN is mapped to a Physical Page Number (PPN) table of the NAND. In at least one example embodiment, the host 102 sends to the storage device 104 the mapping information which maps the cache page(s) to the associated LBA entry/entries. With this information, the storage device 104 can identify the associated LPN table entry/entries and map the LPN to the associated PPN entry/entries to perform the write operation of the data in the NAND pages.

In at least one example embodiment, the storage device 104 flushes the data to the NAND pages from the cache buffer.

FIG. 5 is a schematic block diagram illustrating a system of triggering automatic flush operation from volatile cache by a storage device, according to various example embodiments as disclosed herein. As shown in the FIG. 5, the storage device 104 detects the write operation with a write address snooper that detects whether a write operation has been issued by determining whether a write TLP has been transmitted by a host. Further, based on the cache size as determined by the page hit bitmap and the results of the determination of whether a write operation has been detected by the write address snooper, and/or the page mapping table, the storage device 104 triggers a flush trigger logic. The storage device 104 automatically flushes the data present in the cache buffer to the NAND memory 106.

The example embodiments disclosed herein can be implemented through at least one software program running on at least one hardware device and performing network management functions to control the elements. The elements shown in FIGS. 1 and 3 include blocks which can be at least one of a hardware device, or a combination of a hardware device and a software module.

The units and/or modules described herein may be implemented using hardware components, software components, or a combination thereof. For example, the hardware components may include microcontrollers, memory modules, sensors, amplifiers, band-pass filters, analog to digital converters, and processing devices, or the like. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors, multi-core processors, distributed processing, or the like.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, or computer storage medium or device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of some example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

It should be understood that example embodiments described herein should be considered in a descriptive sense only and not for purposes of limitation. Descriptions of features or aspects within each device or method according to example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

1. A method of performing a write operation using a storage device,
the method comprising:
detecting a write operation using a PCIe (Peripheral Component Interconnect Express) write TLP (Transaction Layer Packet); and
automatically performing the write operation of data to a non-transitory storage medium included with the storage device based on at least one desired criterion, without receiving an explicit write command from a host device.

2. The method of claim 1, wherein the detecting the write operation using the PCIe write TLP includes receiving a LBA (logical block address) mapping command from the host device, the LBA mapping command indicating mapping of an LBA to a cache buffer index.

3. The method of claim 1, wherein the at least one of the desired criterions comprises a battery backup presence criterion, a cache size criterion, and a device policy criterion.

4. The method of claim 1, wherein the automatically performing the write operation of the data to the non-transitory storage medium includes flushing the data from a cache to the storage medium.

5-8. (canceled)

9. A method comprising:
receiving, using at least one processor, a Peripheral Component Interconnect Express (PCIe) Transaction Layer Packet (TLP) related to a data storage device, the received TLP including data;
determining, using the at least one processor, whether the received TLP relates to a write command and whether at least one desired criterion is satisfied; and
based on results of the determining, automatically performing, using the at least one processor, a write operation using the data to the data storage device.

10. The method of claim 9, wherein the data storage device includes a NAND type non-transitory computer readable medium.

11. The method of claim 9, wherein the at least one desired criterion is a battery backup presence criterion, a cache size criterion, and a device policy criterion.

12. The method of claim 10, further comprising:
determining, using the at least one processor, whether a power failure event has occurred; and
based on results of the determining whether a power failure event has occurred, automatically performing, using the at least one processor, a write operation using data stored in a cache related to the data storage device to the NAND type non-transitory computer readable medium.
